(19) United States
(12) Patent Application Publication
(10) Pub. No.: US 2024/0141500 A1
(43) Pub. Date: May 2, 2024

(54) PRODUCTION METHOD FOR A CATALYST-COATED THREE-DIMENSIONALLY STRUCTURED ELECTRODE

(71) Applicant: NANO CATS GMBH, Berlin (DE)

(72) Inventors: Denis BERNSMEIER, Berlin (DE); Ralph KRÄHNERT, Berlin (DE); Michael BERNICKE, Berlin (DE)

(73) Assignee: NANO CATS GMBH, Berlin (DE)

(21) Appl. No.: 18/272,234

(22) PCT Filed: Jan. 14, 2022
(86) PCT No.: PCT/EP2022/050728

§ 371 Date: Jul. 13, 2023

(30) Foreign Application Priority Data
Jan. 15, 2021 (EP) 21151795.8

(51) Int. Cl. C23C 18/12; C25B 11/032; C25B 11/052; C25B 11/056; C25B 11/077; H01M 4/86; H01M 4/88; H01M 4/90

(52) U.S. Cl. CPC C23C 18/1295; C23C 18/1216; C23C 18/1241; C25B 11/032; C25B 11/052; C25B 11/056; C25B 11/077; H01M 4/8605; H01M 4/8807; H01M 4/8842; H01M 4/8882; H01M 4/9016

(57) ABSTRACT

A method for producing a catalyst-coated three-dimensionally structured electrode includes synthesizing a mesoporous catalyst coating onto a three-dimensionally structured metal substrate by first generating a suspension from a template, a metal precursor, and a solvent and then applying the suspension as a film to the three-dimensionally structured metal substrate. The three-dimensionally structured metal substrate is then dried so that the solvent within the suspension film evaporates and a layer of a catalyst precursor with integrated template structure is obtained. The three-dimensionally structured metal substrate comprising catalyst precursors is then subjected to a thermal treatment so that a mesoporous catalyst coating is created. The invention additionally relates to an electrode produced by the above method and also to an electrochemical cell comprising such an electrode.

### BACKGROUND OF THE INVENTION

The invention relates to a method for producing a catalyst-coated three-dimensionally structured electrode. A first production step involves making available a three-dimensionally structured metal substrate. Subsequently, a mesoporous catalyst coating is synthesized onto the three-dimensionally structured metal substrate. For the synthesis a solution or suspension consisting of a template, a metal precursor and a solvent is preferably first generated. The solution or suspension is then applied to the three-dimensionally structured metal substrate, so that a film forms on the three-dimensionally structured substrate. The three-dimensionally structured substrate is then dried at a temperature T₁, so that the solvent within the film evaporates and a coating of a catalyst precursor with integrated template structures is obtained. Subsequently, the three-dimensionally structured metal substrate comprising the catalyst precursors is subjected to a thermal treatment, so that a mesoporous catalyst coating is obtained.

The invention furthermore relates to an electrode produced with the above-described method, as well as to an electrochemical cell with such an electrode.

In electrolytic cells for the water decomposition and fuel cells for the reconversion of hydrogen in the form of gas, binder-dispersed catalyst powders are normally applied to a membrane with the aid of spraying, screen printing or doctor-blading. Methods of this type are known, for example, from German patent document DE 19544323A1 and US Published Patent Application No. 20120094210A1.

When producing a catalyst coating with the above-mentioned techniques, it is not possible to realize a uniform coating with adjustable porosity and without the use of a binder. Binder-free and mesoporous templated anode materials especially show improved activities in the half-cell measure for the oxygen evolution (OER). It has turned out that iridium-containing mesoporous coatings achieve a noticeably higher Ir mass activity than comparable binder-based catalyst coatings produced with the aid of ink methods (see also FIG. 4).

A direct coating of the membrane with a binder-free mesoporous templated catalyst is not possible since the synthesis of such a catalyst (without binder) requires a thermal treatment. The thermal treatment results in destroying the membrane.

To allow the use of the highly active catalyst coatings in an electrolyser or a fuel cell, an alternative method had to be found which would permit the transfer of the mesoporous coating from the half-cell to the full cell measure.

US Published Patent Application No. 2019/0211464 A1 discloses a method for producing an electrode for the electrolysis. For this, a coating solution is initially produced, comprising a platin group metal precursor, a rare earth metal precursor, an organic solvent and a solvent on amine base. The coating solution is applied to a metal substrate to form a catalyst coating. Subsequently, the catalyst coating is dried and is subjected a heat treatment. The selection of the metal substrate is not limited and it can be porous, such as a grid, a metal foam or an expanded metal. The catalyst coating as such is not shown to be porous. As a result, the catalyst coating does not have a suitable specific surface and is disadvantageous with respect to its mass.

European Patent document EP 3617348A1 discloses an oxide-dispersed porous metal body which can be a porous metal body that is placed into a nickel bath with sulfamate. The coating is used for producing an electrode. The coating itself does not contain pores.

Chinese Patent document CN 110783574A discloses a method for producing a fuel cell electrode. Said method uses a foam metal that is placed into an organic solution and then removed again. Further production steps can also be taken, such as washing with de-ionized water. A catalyst powder, a polymer binder and an organic solvent are furthermore uniformly mixed to obtain a catalyst sludge which is applied to the metal foam. Macro porosity is achieved through the structure of the foam metal. However, this restricts the distribution, the size and the shape of the pores to those of the metal foam, in particular to macro pores. Macro pores are a disadvantage for increasing the efficiency of a catalyst because they result, for example, in an unfavorable ratio of surface to volume.

US Published Patent Application No. 2021/0140058 A1 also describes a method for producing a catalyst coating for an electrode. A coating solution is first made available for this and is applied to a metal substrate. The metal substrate can be pretreated, for example by sand blasting, chemical etching or a thermal spraying technique in order to obtain irregularities (respectively “roughness,” irregularities). Further pretreating steps include a salt treatment or acid treatment. The coating solution can subsequently be applied to the pretreated substrate and can be heat-treated in a convection furnace and/or an electro furnace. An efficient configuration of the coating solution on the metal substrate is only conditionally possible with this method.

A need consequently exists for producing an efficient catalyst coating, especially in connection with a coating for electrodes.

It is therefore an object of the invention to remove the disadvantages according to the prior art and to make available an electro-chemical cell that comprises a highly active, binder-free mesoporous templated catalyst coating. In particular, it is an object of the invention to provide an electrode for such an electro-chemical cell and a method for producing this electrode.

### SUMMARY OF THE INVENTION

The above and other objects are achieved according to an embodiment of the invention by the provision of a method for producing a catalyst-coated three-dimensionally structured electrode, comprising the following steps:
a) making available a three-dimensionally structured metal substrate;
b) producing a suspension comprising a template, a metal precursor, and a solvent;
c) applying the suspension to the three-dimensionally structured metal substrate, so that a suspension film forms on the three-dimensionally structured substrate;
d) drying the suspension film on the three-dimensionally structured metal substrate at a temperature T1, so that the solution contained in the suspension film evaporates and a coating of a catalyst pre-stage with integrated template structure is obtained; and
e) thermally treating the three-dimensionally structured metal substrate comprising the catalyst pre-stage at a second temperature T2 and a calcination time t2, so that a mesoporous catalyst coating develops.

The method according to the invention is a departure from the prior art because catalysts are not applied—as is frequently the case—via a binder-based dispersion with the aid of a suitable method (spraying, brushing on, screen-printing, blade-spreading), but are deposited binder-free and with a defined pore structure on a three-dimensional substrate (immersion-coating) and are subsequently implemented in a full-cell measure Eliminating a binder in this case advantageously does not result in a reduction of the volume-related electrical conductivity of the catalytically active material—contrary to the known binder-containing catalysts according to the prior art. A higher catalyst efficiency is thus obtained with the method according to the invention. In addition, tightly packed pore structures result in a coating without cracks and, in the case of small mesopores, to the best possible middle course of surface and accessibility of educts and products while avoiding diffusion limits.

It has turned out that the use of three-dimensionally structured electrodes results in essential advantages for various applications, especially for the use in electrochemical cells. Three-dimensionally structured electrodes have an especially large specific surface per volume unit, which thus permits an improved interaction of the electrode with a surrounding medium. In particular, it permits an improved gas bubble transport owing to the enlarged surface per volume unit. A method for producing a three-dimensionally structured electrode with nano-structured mesoporous templated catalyst coating is not known so far from the prior art, nor has it been proposed.

As previously discussed, one essential advantage of the present invention is the binder-free production of a catalyst. Binders are normally required to ensure a mechanical adherence of the particles of a catalyst powder to each other as well as to the substrate and—as is the case for the water electrolysis—to ensure a fast proton transport. The method according to the invention results in covalent-bound nets of the catalyst, thus generating—binder-free—a sufficient internal structural cohesion. One essential disadvantage of the binder is that it reduces the electron conductivity, thus considerably reducing the catalytic efficiency of active centers. A further disadvantage of the binder is the blocking of active centers.

Within the meaning of the invention, a three-dimensionally structured substrate is preferably embodied such that it can assume a spatial structure, meaning an expansion in any spatial direction. Sequences of terms is advantageously understood to mean a three-dimensional, meaning spatial, arrangement of structural elements on the inside (or also the surface) of a substrate. The geometry of a three-dimensional structuring advantageously aims to achieve an increase in the surface area per substrate volume which, for example, can be achieved through regular pores, raised areas, depressions, openings in a three-dimensional substrate. An increased surface area advantageously leads to an improved interaction of the substrate with the surrounding medium.

The three-dimensionally structured metal substrate is preferably cleaned and pretreated in a preparatory step for to the method. In particular, a pretreatment step can involve etching which results in improved adherence for the subsequently applied mesoporous catalyst coating since undesirable oxides and dirt are advantageously removed. It is understood that different methods can also be used for the pretreatment for removing oxides and dirt.

The combination of the present method steps leads to a surprising synergy effect, resulting in the advantageous characteristics and therewith associated total success of the invention, wherein the individual characteristics are interdependent. One important advantage of the method according to the invention is furthermore the extremely fast, reproducible, and economic synthesis procedure.

The use of a three-dimensionally structured metal substrate did not suggest itself to one skilled in the art. Owing to the thermal treatment within the synthesis procedure, it had to be expected that the three-dimensionally structured metal substrate would warp. Furthermore, it had to be expected that a thermal treatment of the three-dimensional metal substrate would lead to disadvantageous internal stresses and, in some circumstances, to cracks within the material. In particular grid structures, nets and the like have a thin mesh which does not withstand high temperatures.

It was therefore surprising for the inventors that the influence of the applied suspension to a large degree prevents this type of material behavior. It was not to be expected that in addition to the advantageous characteristics (obtained later following the thermal treatment) as highly active catalyst in electrochemical cells, the applied suspension/catalyst pre-stage would also have a protective effect on the electrode in connection with a thermal treatment.

It has furthermore proven advantageous that following the immersion coating, the suspension of the structured three-dimensional substrate is homogeneous and uniform after the application to all geometric shapes (extensions, undercuts or indentations, round areas, peaks, etc.). In particular when compared to a substrate with continuously flat area, the three-dimensionally structured substrate leads to an improved adherence of the suspension.

Surprisingly, the occurrence of so-called edge effects was not particularly pronounced following the immersion coating. Even though it is known that edge effects can lead to thicker film segments, it is possible to obtain coatings with homogeneous coating thickness, given the correct composition.

For additional preferred embodiments, a solution can also be produced that comprises a template, a metal precursor and a solvent, as detailed in step b).

According to another embodiment there is provided a method for producing a catalyst-coated three-dimensionally structured electrode, comprising the following steps:
a) making available a three-dimensionally structured metal substrate;
b) producing a solution comprising a template, a metal precursor and a solvent;
c) applying the solution to the three-dimensionally structured metal substrate, so that a film forms on the three-dimensionally structured metal substrate;
d) drying the film on the three-dimensionally structured metal substrate at a temperature T1 so that the solvent in the coating evaporates and a coating of a catalyst pre-stage with integrated template structures is obtained; and
e) thermally treating the three-dimensionally structured metal substrate comprising the catalyst pre-stage at a second temperature T2 and a calcinating time t2, so that a mesoporous catalyst coating results.

According to further embodiments, several templates, metal precursors and/or solvents can also be used. It is furthermore preferable if the template is a pore template.

According to another embodiment of the invention there is provided a method for producing a catalyst-coated three-dimensionally structured electrode, comprising the following steps:
a) making available a three-dimensionally structured metal substrate;
b) producing a solution or suspension comprising one or several pore templates, one or several metal precursors, and one or several solvents;
c) applying the solution or suspension to the three-dimensionally structured metal substrate, so that a film forms on the three-dimensionally structured metal substrate;
d) drying the film on the three-dimensionally structured metal substrate at a temperature T1, so that the solvent or solvents in the film evaporate and a coating of a catalyst pre-stage with integrated template structures is obtained; and
e) thermally treating the catalyst pre-stage comprising the three-dimensionally structured metal substrate at a second temperature T2 and a calcinating time t2, so that a mesoporous catalyst coating is obtained.

The film can be selected from a group comprising a solution film (film created with a solution) or a suspension film (film created with a suspension).

According to other embodiments several mesoporous catalyst coatings may be generated in step e).

It has proven advantageous that the mesoporous coating generated through immersion coating adheres especially well to the substrate. Testing of the adherence via tape test shows that the coating material is hard to remove from the substrate. Sprayed-on substrates by comparison, which were thermally treated under the same conditions, show clearly worse adherence, wherein this can be explained with the uniform film morphology. Multi-layered coatings also show good adherence. Another advantage is that the mesoporous coatings can be applied easily in several layers. A desired geometric metal load can therefore be adjusted purposely across its width, for example, with the immersion coating. The mesoporous morphology in that case helps achieve a high geometric load since the porous structure can better compensate for tensions within the coating. During the calcination/removal of the template, the film shrinks along the surface normals (resulting in ellipsoid pores) and tensions within the coating which could lead to detachment are compensated. Surprisingly, it was found that through the preferred use of a template, multi-coating mesoporous catalyst coatings could be generated which made it particularly efficient to realize an electrolysis.

The use of a metal substrate is advantageously suited for adopting geometrically a three-dimensionally structured form, wherein the substrate continues to have sufficiently high rigidity because of the material (metal). A stable substrate design can thus be achieved which can withstand tensile and compressive loads and thus allows a particularly easy insertion into a full-cell scale. In addition, metal can be processed easily so that the metal substrate can assume all geometric shapes.

According to another embodiment, the metal substrate is a metal selected from the group comprising: nickel, silver, titanium, iron, manganese, cobalt, gold, iridium, copper, platinum, palladium, osmium, rhodium, ruthenium, aluminum, wolfram (tungsten), tin, zinc, lead, germanium, silicon as well as their alloys. The aforementioned materials are advantageous because they have generally good electrical conductivity, but simultaneously also have good chemical stability to a surrounding medium, especially when used for electrolytic cells or galvanic cells. It is understood that the metal substrate also can comprise a combination of the aforementioned metals.

In another embodiment, the method the mesoporous catalyst coatings are produced on three-dimensionally structured Ti substrates with differing geometry. Ti substrates in particular are suitable since they comprise a natural, thin oxide coating on the surface. If we coat these substrates, oxygen functions on the substrate surface can enter a covalent and/or ionic bond with the catalyst coating during the thermal treatment, thus resulting in a strong mechanical adherence.

According to another embodiment, the metal substrate also comprises additional, electrically conducting materials from the group comprising glassy carbon, boron-doped diamond, carbide, nitride, oxide. These are may be present in smaller amounts in the metal substrate, wherein smaller amounts denotes a range of small volume percentages of the total substrate. The metal substrate of different preferred embodiments is essentially composed of one or several of the aforementioned electrically conductive materials.

The synthesized, mesoporous catalyst coating is preferably nanostructured. Nan-structuring is understood to refer to the structuring of a solid body on an atomic level. With the aid of a targeted modification (implantation), atomic, chemical and other, mostly surface-near, characteristics of the solid body are changed.

A nanostructured, mesoporous catalyst coating is advantageously understood to be an ordered nano structure of the mesoporous catalyst coating. It means that a catalyst coating repeatedly (periodically) comprises in the same way approximately the same structural elements (e.g. strung together). Surprisingly it was found that the forming of an ordered meso-structure is not disturbed by the geometric design (e.g. bulging, depression) of the substrate surface.

According to other embodiments, one or several metal salts are dispersed in one or several suitable solvents for the catalyst pre-stage, together with one or several templates, and this mixture is transferred to the three-dimensional metal substrate. The subsequent vaporizing of the solvent results in an advantageous periodic arrangement of the template, surrounded by a catalyst pre-stage. A subsequent thermal treatment at preferred temperatures ranging from 300° C.-800° C. burns the template and transforms the pre-stage to the actual catalyst, preferably a metal oxide. By removing the template, pores are created which are linked and provide a particularly advantageous surface for catalytic processes.

The synthesis approach is based on templates functioning as place holders for a desired pore structure. During the synthesis, the template is enclosed by the surrounding material (catalyst pre-stage) and, following its removal, a defined porous material is left. Depending on the template size, pore structures are consequently generated which have pore sizes of several micrometers up to a few nanometers. Materials with an orderly pore structure and a mono-modal pore size distribution could advantageously be synthesized via the so-called templating methods. With this synthesis approach, templates function as place holders for the desired pore shape. By using a template, a pore morphology of the catalyst coating could be generated. In particular, the catalyst coating could be embodied mesoporous, which made it possible to achieve an especially high mechanical stability. The use of the template makes it possible to provide a purposely adjusted, reproducibly generated pore distribution with especially high specific surface for the catalyst coating. The reproducibility is advantageous when considering technical applications.

The template of additional embodiments comprises surfactants, block copolymers and/or dendritic core shell polymers. This template results in mesoporous structuring within the catalyst coating, wherein the template can form micells or can have other structuring. The template for alternative embodiments can also have a non-micell forming core shell macromolecule, so to speak a uni-molecular micell. Block copolymers can furthermore also take on lamellar structures.

According to another embodiment, templates are designed as soft templates. Soft templates are deformable, structure-directing units. They can be micells or lamellar structures of amphiphilic polymers (often block polymers). The micells or lamellas typically form above a critical concentration for a polymer dispersed in a solution. The soft templates also include dendritic or hyper-branched core shell polymers, wherein core and shell of the polymers show different hydrophilicities and are thus also amphiphile.

According to another embodiment, templates are embodied as hard templates. Hard templates are rigid, structure-directional units. Nano structured hard templates include metals, oxides, frequently silicon oxides (e.g. MCM group, SBA group, FDU group, KIT group, MSU group, TUD group, HMM group, FSM group) as well as carbons (e.g. CMK group). These hard templates can be individual nano particles or larger nano-structured configurations.

According to another embodiment, the method step of drying can also be configured such that the drying occurs over a very short time interval. For example, during a time interval raging from the application of the suspension or solution onto the metal substrate to the thermal treatment. In practical operations, the time interval can include the following: pulling the three-dimensional metal substrate from a container comprising the solution or suspension and inserting it directly into a furnace for the thermal treatment. Conducting a drying operation in this way results in a particularly quick realizing of the catalyst coating synthesis onto the dimensionally structured metal substrate.

According to a different embodiment of the drying method step, the time interval from applying the suspension or solution onto the metal substrate up to the thermal treatment can proceed as follows: pulling the three-dimensional metal substrate from a container containing the solution or suspension, air-drying it (e.g. for about 5 minutes), then subjecting it to a thermal treatment so as to basically remove any remaining solvent completely and/or to stabilize the coating.

According to a different embodiment, the method is characterized in that the solution or suspension from step c) is applied through immersion coating. It did not suggest itself to one skilled in the art that by using an immersion coating method, a three dimensionally structured metal substrate could be provided with a homogeneous catalyst coating having a templated pore structure. A templated pore structure advantageously refers to obtaining a pore structure (structure comprising pores) using a template. The immersion coating method furthermore has the advantage that especially undercut areas of a three-dimensionally structured metal substrate can also be coated easily.

The immersion coating has several additional advantages. For example, several three-dimensionally structured metal substrates can be coated simultaneously, thus permitting an especially economic production. An immersion coating furthermore also results advantageously in a short processing time because a brief immersion into the solution or suspension is already sufficient to obtain a preferred catalyst coating. An immersion coating is furthermore very resource protecting because no material is wasted (solution or suspension in one container). For the immersion coating it can furthermore be preferable if a substrate is first placed into a container and the solution is then filled in and removed again.

The method according to another embodiment the three-dimensionally structured metal substrate takes the form of a net, foam, grid, strainer, fabric or mesh.

Another embodiment features a three-dimensionally structured metal substrate embodied as a net or grid. The net or grid embodiments are advantageous because those embodiments can be obtained easily from the above-described materials. Those configurations furthermore make it advantageously possible to easily deform the metal substrates.

According to another embodiment of the method, the temperature T2 is in the range of 200° C. to 1000° C., preferably between 300° C. to 800° C., and that the calcination time t2 is in the range of 1 minute to 1440 minutes, in particular between 10 minutes and 120 minutes, preferably between 10 minutes and 60 minutes. Especially within the described parameters, the template can advantageously burn completely, so that a nano-structured, mesoporous catalyst coating is obtained.

According to another embodiment, the template can also be detached/washed out of the catalyst stage by using a suitable medium. It is understood that a combination of heat treatment and detaching of the templates can also successively take place. Insofar as templates are removed with the aid of a medium—without being burned—these template structures can advantageously be processed and/or used once more.

The catalyst pre-stage may be calcinated for the thermal decomposition of the template and to convert the inorganic species to a crystalline metal oxide.

Calcination leads to a drastic volume loss for the coating, caused by the conversion of the precursor into the oxide, the incineration of the template, and the conversion of the amorphous pore wall to a crystalline material. Since the adherence of the coating on the substrate is comparably strong, among other things because of the covalent bonding between the substrate surface and the metal oxide species, the coating contracts exclusively perpendicular to the substrate, without causing tears in the coating.

All parameter ranges disclosed in this document, e.g. temperatures, forces, pressures, distances and the like, of course comprise all values within the indicated ranges, as well as their maximum and minimum limit values. It is obvious to one skilled in the art that the values are also subject to certain fluctuations. In the present case, we therefore have a temperature range of approximately 200° C. to 1000° C., and especially preferred 300° C. to 800° C., as well as a calcinating time of preferably about 1 minute to 1440 minutes, especially approximately 10 to 120 minutes. This can be transferred analogous to all other parameter ranges of the document.

Terms such as “essentially,” “approximately,” “about” and “circa” describe a tolerance range of less than ±40%, preferably less than ±20%, especially preferred less than ±10%, even more preferred less than ±5%, and in particular less than ±1% and always comprise the exact value. “Similar” preferably describes quantities that are “approximately the same.” “In part” preferably describes quantities up to at least 5%, especially preferred 10% and particularly preferred up to at least 20%, in some cases even up to at least 40%.

The thermal treatment according to one preferred embodiment takes place in heating systems. To remove the template, for example, a tube furnace in the air flow or a muffle furnace can be used. Furnaces of this type have a uniform temperature distribution, so that the process can advantageously be repeated. The exhaust heat from the furnaces can furthermore advantageously be used for additional processing steps (e.g. drying) to save energy associated therewith.

In place of the heating with a furnace, the thermal treatment of a different advantageous embodiment can also take place using different methods as follows. The substrate comprising the catalyst pre-stages is preferably treated thermally via rapid thermal annealing (RTA) with the thermal discharge from a halogen lamp. The substrate comprising the catalyst pre-stages is furthermore advantageously warmed via flash lamp annealing, which advantageously results in a quick heating up and an exclusive heating of the surface. Additionally preferred is the laser annealing method. This method leads to an even faster heating of the substrate comprising the catalyst pre-stages, wherein an extremely short penetration depth is achieved and only the surface is heated. Also possible would be heating a suitable substrate with an inductive furnace, which also results in very rapid heating. It may furthermore be preferable to use an infrared radiator for the heating.

In another embodiment the method is characterized in that the temperature T1 ranges from 18° C. to 250° C. The coating of the three-dimensional metal substrate can occur at temperatures ranging from room temperature up to 80° C. As a result, very little energy is advantageously used. In addition, the thermal discharge of the heating systems is sufficient for these temperatures as drying energy to achieve a quick drying of the suspension film, which additionally results in considerable economic savings for the method.

According to another embodiment of the invention, the method is characterized in that the suspension comprises one or several amphiphile block co-polymers.

For templating ordered mesoporous catalyst coatings, amphiphile block co-polymers can be used which comprise a hydrophilic poly-ethylene oxide block (PEO).

Amphiphilic molecules are preferred templates for the synthesis of ordered mesoporous solid materials. They advantageously form micelles through self-organization and arrange themselves into fluid-crystalline phases. These fluid crystals, having a nano-structuring ranging typically from 2 nm to 50 nm, preferably serve as endo templates during the synthesis of mesoporous oxides.

According to a different embodiment, the three-dimensionally structured metal substrate comprising the catalyst pre-stages is thermally treated in an inert atmosphere. The block copolymer substrates also decompose in inert atmospheres at temperatures above 300° C.

According to another embodiment, the method the amphiphilic block copolymer may be selected from the group composed of AB block copolymers (poly ethylene oxide block polystyrene (PEO-PS); poly ethylene oxide block polymethyl methacrylate (PEO-PMMA); poly-2-vinyl pyridine block poly allyl methacrylate ((P2VP-PAMA); poly butadiene block polyethylene oxide ((PB-PEO); poly isoprene block poly dimethyl amine ethyl methacrylate ((PI-PDMAEMA); poly butadiene block poly dimethyl aminoethyl methacrylate (PB-PDMAEMA); poly ethylene block poly ethylene oxide ((PE-PEO); polyisobutylene block polyethylene oxide (PIB-PEO) and poly (ethylene-co-butylene) block poly (ethylene oxide) (PEB-PEO); poly styrene block poly (4 vinyl pyridine (PS-P4VP); poly isoprene block poly ethylene oxide (PI-PEO); poly dimethoxy aniline block poly styrene (PDMA-PS); polyethylene oxide block poly-n-butyl acrylate (PEO-PBA); poly butadiene-block-poly (2 vinyl pyridine (PB-P2VP)); poly ethylene oxide-block-polyactide (PEO-PLA); polyethylene oxide block polyglycolide (PEO-PLGA); polyethylene oxide block polycaprolactone (PEO-PCL); polyethylene block polyethylene glycol (PE-PEO); polystyrene block poly methyl methacrylate (PS-PMMA); polystyrene block poly acrylic acid (PS-PAA); polypyrrole block polycaprolactone (PPy-PCL); polysilicon block poly ethylene oxide (PDMS-PEO) ABA block copolymers (polyethylene oxide block poly butadiene block polyethylene oxide (PEO-PB-PEO); polyethylene oxide block poly propylene oxide block polyethylene oxide (PEO—PPO-PEO); polypropylene oxide block polyethylene oxide block polypropylene oxide (PPO-PEO-PPO); polyethylene oxide block poly isobutylene block polyethylene oxide (PEO-PIB-PEO); polyethylene oxide block polybutadiene block polyethylene oxide (PEO-PB-PEO)); polyactide block polyethylene oxide block polyactide (PLA-PEO-PLA); polyglycolide block polyethylene oxide block polyglycolide (PGLA-PEO-PGLA); polyactide-co-caprolactone block polyethylene oxide block polyactide-co-caprolactone (PLCL-PEO-PLCL); polycaprolactone block polytetrahydrofuran block polycaprolactone (PCL-PTHF-PCL); polypropylene oxide block polyethylene oxide block polypropylene oxide (PPG-PEO-PPG); polystyrene block polybutadiene block polystyrene (PS-PB-PS); polystyrene block polyethylene-ran-butylene block polystyrene (PS-PEB-PS); polystyrene block polyisoprene block polystyrene (PS-PI-PS); ABC block copolymers (polyisoprene block polyethylene oxide (PI-PS-PEO); polystyrene block polyvinyl pyrrolidone block polyethylene oxide (PS-PVP-PEO); polystyrene block poly-2-venylpiridine block polyethylene oxide (PS-P2VP-PEO); polystyrene block poly-2-venylpiridine block polyethylene oxide (PS-P2VP-PEO); polystyrene block poly acrylic acid polyethylene oxide (PS-PAA-PEO)); polyethylene oxide block polyactide block decane (PEO-PLA-decane); as well as other amphiphilic polymers (polyethylene oxide alkyl ether (PEO-Cxx), for example Brij35, Brij56, Brij58) or mixtures thereof, preferably PEO-PB, PEO-PPO, PEO-PB-PEO, PEO-PPO-PEO.

According to another embodiment of the method a metal salt or several metal salts of respectively different metals, or their hydrates, are used as metal precursor.

According to another embodiment, metal nano particles can also be used for the metal precursor, which can be deposited mesoporous templated as a coating with the aid of polymer templates. Metal nano particles can be obtained from the industry, if applicable in the form of waste products, and can thus be used again in a recycling process.

The method according to a different embodiment includes selecting the metal salts from the group that consists of metal nitrate, metal halogenide, metal sulfate, metal acetate, metal citrate, metal alkoxide or mixtures thereof.

Additional salts can also be used for alternative embodiments, insofar as these are soluble in the suitable solvent, if applicable by adding additional complexing materials.

According to another embodiment of the method the metals contained in the metal precursor are selected from the group consisting of alkaline metals, preferably lithium, sodium, potassium, rubidium, cesium, alkaline earth metals, preferably magnesium, calcium, strontium, barium; metals from the third main group of the periodic system, preferably boron, aluminum, indium, gallium, thallium; metals of the fourth main group of the periodic system, preferably tin, silicon, germanium, lead; metals of the fifth main group of the periodic system, preferably bismuth and transition metals, preferably iridium, ruthenium, cobalt, zinc, copper, manganese, cadmium, vanadium, yttrium, zirconium, scandium, and titanium.

According to another embodiment, the method includes using ruthenium and/or iridium and/or titanium for the metal precursor. The combination of the metals in particular leads to a catalyst coating with high integrity and stability. Ruthenium and iridium based coatings show high activity for uses in the oxygen evolution and chlorine evolution. Also, the presence of titanium oxide in the coating improves the adherence to the titanium substrate.

The method of one preferred embodiment is characterized in that mesoporous Ru and Jr containing catalyst coatings are synthesized onto three-dimensionally structured Ti substrates with different geometry.

According to one preferred embodiment, the method is characterized in that water, or a C1-C4 alcohol, C2-C4 ester, C2-C4 ether, formamide, acetone nitrile, acetone, tetrahydrofuran, benzyl, toluol, dimethyl sulfoxide, dichloromethane, chloroform or mixtures thereof are used, preferably methanol, ethanol, formamide and/or tetrahydrofuran.

The advantages and preferred embodiments of the inventive method are to be transferred analogous to the electrode according to the invention, as well as the electro-chemical cells according to the invention, and vice versa.

According to one preferred embodiment, the invention relates to an electrode for an electro-chemical cell, preferably produced according to the above-described method, characterized in that the electrode is a three-dimensionally structured metal substrate and comprises a nano-structured mesoporous catalyst coating.

It is standard procedure with electro-chemical cells—in particular for water splitting in the full cell scale—to spray catalysts in the form of dispersed powders together with a binder onto a Nafion membrane and subsequently install it into the electro-chemical cells, preferably an electrolyser. Extensive (inventive) considerations were therefore necessary which led to inserting a three-dimensionally structured electrode with a nano-structured mesoporous catalyst coating in place of the catalyst powder into an electro-chemical cell.

An electrode comprising a nano-structured mesoporous catalyst coating has substantial advantages. Thus, the higher mass activity of the species of a mesoporous catalyst coating has been proven (see also FIG. 4).

An electrode of this type is furthermore advantageous because it has an especially large specific surface per component volume because of the porous or open-pore design and, additionally, has a high mechanical stability which stabilizes the complete electro-chemical cell.

A nanostructured mesoporous catalyst coating in particular has essential advantages. It has turned out that in the half-cell scale, mesoporous templated catalyst coatings have a clearly higher mass activity of the electrochemically active species than comparable traditional catalyst coatings, for example produced with an ink-based method. The preferred mesoporous design of the catalyst coating was advantageously produced with the aid of a thermal treatment of the catalyst pre-stages by using a template, preferably a soft template.

According to a further preferred embodiment, the electrode is characterized in that the three-dimensionally structured metal substrate takes the form of a net, foam, grid, fabric and/or mesh.

According to a different preferred embodiment, the invention relates to an electrochemical cell comprising a binder-free catalyst.

For one preferred embodiment, the electrochemical cell comprises an electrode of the aforementioned type. The electrode according to the invention has the advantage of having, in particular, a binder-free catalyst with an essentially homogeneous pore structure, resulting in optimum material transport of educts and products and correspondingly to a higher catalytic activity.

An electrochemical cell is preferably selected from the group comprising: battery, accumulator, fuel cell, electrolyser.

An electrode according to the invention can furthermore preferably be used in connection with the electrolysis for producing chlorine.

Three-dimensionally structured substrates can also be used in medical technology, wherein it is essential for such substrates that they can withstand the increased temperatures of the thermal treatment. For this, mesoporous materials can be used as active ingredient carriers. Macromolecules are stored in the porous system and can be dispersed over longer periods as active agent at suitable locations. The option of a targeted adjustment of the porosity and the material is an important advantage in this case.

### BRIEF DESCRIPTION OF THE FIGURES

The invention is to be explained further with the aid of the following figures, without being restricted to these figures.

FIG. 1—Schematic flow chart of a preferred method for producing a catalyst-coated three-dimensionally structured electrode;

FIG. 2—REM (scanning electron microscope) image showing a comparison of titanium nets before (A) and after (B) a coating with mesoporous iridium oxide coatings;

FIG. 3—Schematic flow chart of a preferred method for producing a catalyst-coated three-dimensionally structured electrode for a comparison to the method according to prior art;

FIG. 4—Diagram representation of electro-catalytic activity as cyclo-voltametric (CV) measurement of two catalyst systems in a water electrolyser;

FIG. 5—Diagram representation of increased catalytic activity of an electrode net with a mesoporous templated catalyst coating used in the chlorine production.

### DETAILED DESCRIPTION

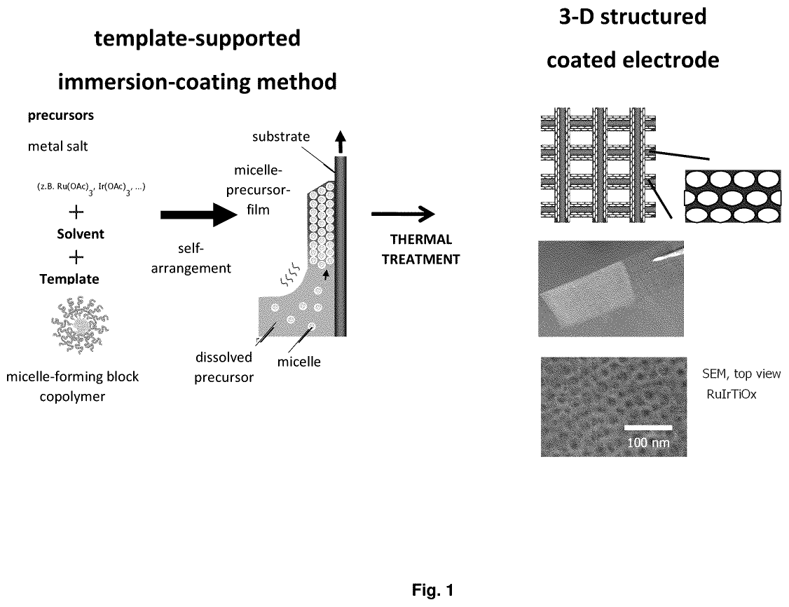

FIG. 1 schematically illustrates the sequence of steps of a preferred method for producing a catalyst-coated three-dimensionally structured electrode. The method preferably comprises a template-supported immersion coating process, wherein a solution is generated for this during a first method step. The solution comprises precursors, solvents and a template. A metal salt—for example Ru(OAc)3 or Ir(OAc)3—is strongly preferred as the precursor. A micelle-forming block copolymer is preferably used for the template. Following the production of the solution, a three-dimensionally structured electrode is immersed in the solution, so that a film can form on the electrode surface when it is pulled out. The solvent preferably evaporates at room temperature already, so that following a short interval the electrode surface has a catalyst pre-stage with integrated micelles. Starting with the self-arrangement of the micelles, an orderly nano structure forms on the surface of the three-dimensionally structured electrode. During a final thermal treatment, the catalyst pre-stage is converted to a catalyst coating. The thermal treatment leads to incineration of the template that forms the micelles, so that a nano structured mesoporous catalyst coating forms. The REM image shows a view from above of a mesoporous templated RulrTiOx coating, calcinated at 450° C., on a titanium net.

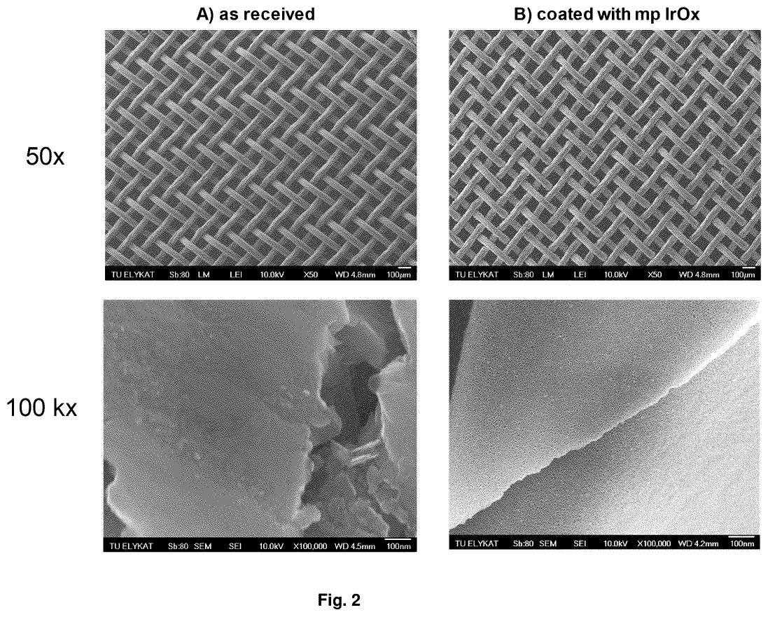

FIG. 2 shows REM pictures of titanium nets, which can advantageously be used as gas diffusion coatings. In particular, the image shows a titanium net prior to (A) and after (B) a coating with mesoporous iridium oxide coatings. The images above show the nets enlarged 50 times; the images below, on the other hand, show the nets 100 000 times enlarged. The coating was calcinated at 400° C. in air.

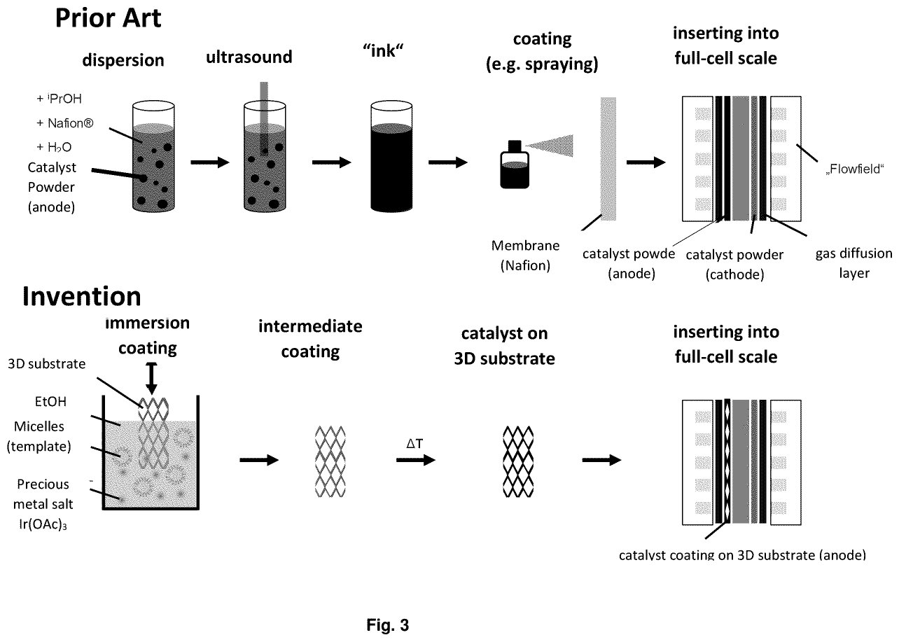

FIG. 3 shows schematically the sequence of steps for a preferred method for producing a catalyst-coated three-dimensionally structured electrode in contrast to a method according to the prior art. For the prior art, ink is produced in that a dispersion comprising preferably isopropyl (iPrOH), Nafion, water, and a catalyst powder are mixed with the aid of ultrasound to form an ink. A substrate, for example a Nafion membrane, is then coated with the ink, preferably through spray-coating. In a final step, the membrane is inserted into the full cell scale.

The method according to the invention, on the other hand, prefers the use of the immersion coating. A suspension is initially generated, for example comprising ethanol, a micelle forming template and a precious metal salt, namely Ir(OAc)3. A three-dimensional substrate is then immersed into a container with the above-described suspension. Pulling the three-dimensional substrate from the suspension leads to a catalyst coating pre-stage on the substrate. With the aid of a thermal treatment, a catalyst coating is then formed and, during a final method step, the three-dimensional substrate is inserted into a full-cell scale.

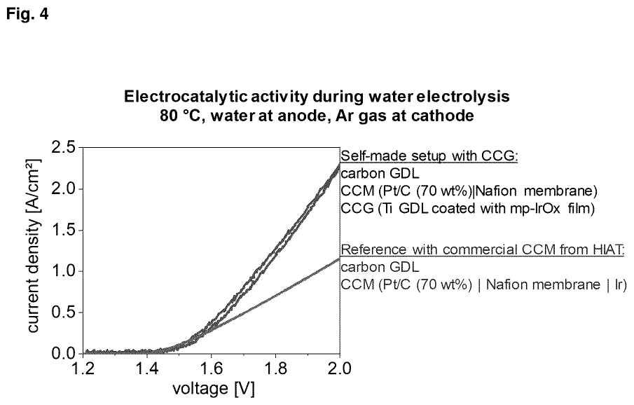

FIG. 4 shows the electrocatalytic activity of a CCG (catalyst coated gas diffusion layer), coated with mesoporous iridium oxide, as anode in contact with a membrane. The membrane is coated on the cathode side with standard Pt/C catalyst (one-sided coated CCM). The setup is compared to a commercially available CCM (catalyst-coated membrane) with the same Pt/C catalyst on the cathode side and a binder-containing Ir coating (CCM coated on both sides) as reference system. The CCG system achieves approximately twice the geometric current density when compared to the binder-containing reference.

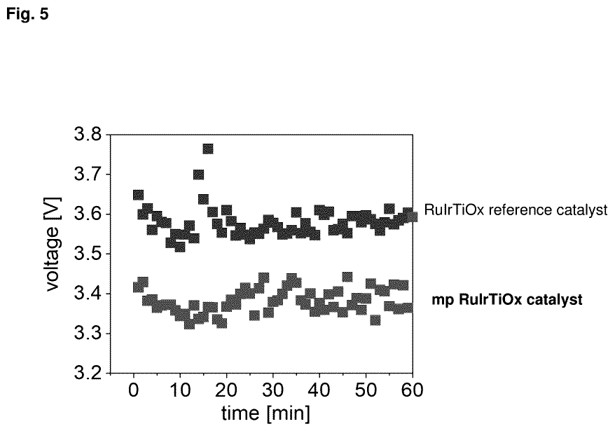

The point diagram visualization shown in FIG. 5 shows increased catalytic activity for three-dimensionally structured electrodes with mesoporous templated catalyst coatings, used in the chlorine production. A reference catalyst was used for the comparison, wherein a three-dimensionally structured electrode was coated with a standard synthesis method and therefore does not comprise a templated mesoporous catalyst coating.

The following marginal conditions were used for the comparison: 80° C.; NaCl (300 g/l) at the anode; NaOH (400 g/l) at the cathode; chrono-potentiometric measurements at 350 mA/cm2; cathode: commercial catalyst on Ni-net; membrane: N982WX; anode: catalyst coating on Ti-net.

1. A method for producing a catalyst-coated three-dimensionally structured electrode comprising the following steps:
a) making available a three-dimensionally structured metal substrate;
b) producing a suspension comprising a template, a metal precursor and a solvent;
c) applying the suspension to the three-dimensionally structured metal substrate, so that a suspension film forms on the three-dimensionally structured metal substrate;
d) drying the suspension film on the three-dimensionally structured metal substrate at a temperature T₁, so that the solvent within the suspension film evaporates and a layer of a catalyst pre-stage with integrated template structures is obtained; and
e) thermally treating the three-dimensionally structured metal substrate, comprising the catalyst pre-stages, at a second temperature T₂ a calcinating time t₂, so that a mesoporous catalyst coating forms.

2. The method according to claim 1, wherein the applying step includes using an immersion coating technique to apply the suspension.

3. The method according to claim 1, wherein
the three-dimensionally structured metal substrate in the applying step includes a net, foam, grid, strainer, fabric and/or mesh.

4. The method according to claim 1, wherein the temperature T₂ is in a range between 200° C. and 1000° C., and that the calcinating time t₂ is in a range between 1 minute and 1440 minutes.

5. The method according to claim 1, wherein the temperature T₁ ranges from 18° C. to 250° C.

6. The method according to claim 1, wherein the suspension comprises at least one amphiphile block copolymer.

7. The method according to claim 6, wherein the at least one amphiphile block copolymer is selected from a group consisting of: AB block copolymers (poly ethylene oxide block polystyrene (PEO-PS); poly ethylene oxide block polymethyl methacrylate (PEO-PMMA); poly-2-vinyl pyridine block poly allyl methacrylate ((P2VP-PAMA); poly butadiene block polyethylene oxide ((PB-PEO); poly isoprene block poly dimethyl amine ethyl methacrylate ((PI-PDMAEMA); poly butadiene block poly dimethyl aminoethyl methacrylate (PB-PDMAEMA); poly ethylene block poly ethylene oxide ((PE-PEO); polyisobutylene block polyethylene oxide (PIB-PEO) and poly (ethylene-co-butylene) block poly (ethylene oxide) (PEB-PEO); poly styrene block poly (4 vinyl pyridine (PS-P4VP); poly isoprene block poly ethylene oxide (PI-PEO); poly dimethoxy aniline block poly styrene (PDMA-PS); polyethylene oxide block poly-n-butyl acrylate (PEO-PBA); poly butadiene-block-poly (2 vinyl pyridine (PB-P2VP)); poly ethylene oxide-block-polyactide (PEO-PLA); polyethylene oxide block polyglycolide (PEO-PLGA); polyethylene oxide block polycaprolactone (PEO-PCL); polyethylene block polyethylene glycol (PE-PEO); polystyrene block poly methyl methacrylate (PS-PMMA); polystyrene block poly acrylic acid (PS-PAA); polypyrrole block polycaprolactone (PPy-PCL); polysilicon block poly ethylene oxide (PDMS-PEO) ABA block copolymers (polyethylene oxide block poly butadiene block polyethylene oxide (PEO-PB-PEO); polyethylene oxide block poly propylene oxide block polyethylene oxide (PEO-PPO-PEO); polypropylene oxide block polyethylene oxide block polypropylene oxide (PPO-PEO-PPO); polyethylene oxide block poly isobutylene block polyethylene oxide (PEO-PIB-PEO); polyethylene oxide block polybutadiene block polyethylene oxide (PEO-PB-PEO)); polyactide block polyethylene oxide block polyactide (PLA-PEO-PLA); polyglycolide block polyethylene oxide block polyglycolide (PGLA-PEO-PGLA); polyactide-co-caprolactone block polyethylene oxide block polyactide-co-caprolactone (PLCL-PEO-PLCL); polycaprolactone block polytetrahydrofuran block polycaprolactone (PCL-PTHF-PCL); polypropylene oxide block polyethylene oxide block polypropylene oxide (PPG-PEO-PPG); polystyrene block polybutadiene block polystyrene (PS-PB-PS); polystyrene block polyethylene-ran-butylene block polystyrene (PS-PEB-PS); polystyrene block polyisoprene block polystyrene (PS-PI-PS); ABC block copolymers (polyisoprene block polyethylene oxide (PI-PS-PEO); polystyrene block polyvinyl pyrrolidone block polyethylene oxide (PS-PVP-PEO); polystyrene block poly-2-vinylpyridine block polyethylene oxide (PS-P2VP-PEO); polystyrene block poly-2-vinylpyridine block polyethylene oxide (PS-P2VP-PEO); polystyrene block poly acrylic acid polyethylene oxide (PS-PAA-PEO)); polyethylene oxide block polyactide block decane (PEO-PLA-decane); and other amphiphilic polymers (polyethylene oxide alkyl ether (PEO-Cₓₓ), including Brij35, Brij56, Brij58) or mixtures thereof, including PEO-PB, PEO-PPO, PEO-PB-PEO, PEO-PPO-PEO.

8. The method according to claim 1, wherein the metal precursor comprises one of a metal salt, several metal salts of respectively different metals, or their hydrates.

9. The method according to claim 8, wherein the metal salts are selected from a group consisting of metal nitrate, metal halogenide, metal sulfate, metal acetate, metal citrate, metal alkoxide or mixtures thereof.

10. The method according to claim 1, wherein the metal precursor comprises a metal selected from a group consisting of alkali metals, alkaline earth metals, metals of the third main group in the periodic system, metals of the fourth main group in the periodic system, metals from the fifth main group of the periodic system and transition metals.

11. The method according to claim 1, wherein the solvent is one water, a C1-C4 alcohol, C2-C4 ester, C2-C4 ether, formamide, acetone nitril, acetone, tetrahydrofuran, benzyl, toluene, dimethyl sulfoxide, dichloromethane or chloroform, or mixtures thereof.

12. An electrode for an electrochemical cell, comprising: a three-dimensionally structured metal substrate and a nano-structured mesoporous catalyst coating thereon.

13. The electrode according to claim 12, wherein the three-dimensionally structured metal substrate comprises a net, foam, grid, fabric or mesh of mixtures of two or more thereof.

14. An electrochemical cell is including an electrode according to the claim 12.

15. The method according to claim 4, wherein the temperature T₂ is in a range between 300° C. and 800° C.

16. The method according to claim 4, wherein the calcinating time t₂ is in a range between 10 and 120 minutes.

17. The method according to claim 10, wherein the group of alkali metals consist of lithium, sodium, potassium, rubidium and cesium; the group of alkaline earth metals consist of magnesium, calcium, strontium and barium; the group of metals of the third main group in the periodic system consist of boron, aluminum, indium, gallium and thallium; the group of metals of the fourth main group in the periodic system consist of tin, silicon, germanium and lead; the group of metals from the fifth main group of the periodic system consists solely of bismuth; and the transition metals consist of iridium, ruthenium, cobalt, zinc, copper, manganese, cadmium, vanadium, yttrium, zirconium, scandium and titanium.

18. The method according to claim 11, wherein the solvent is a mixture of at least two of methanol, ethanol, formamide and tetrahydrofuran.

19. An electrode comprising a three-dimensionally structured metal substrate and a nano-structured mesoporous catalyst coating, wherein the electrode is produced according to the method of claim 1.
